(19) United States
(12) Patent Application Publication
(10) Pub. No.: US 2018/0300794 A1
(43) Pub. Date: Oct. 18, 2018

(54) MULTIDIMENSIONAL PROFILE MATCHING

(71) Applicant: Wrapt, Inc., Washington, DC (US)

(72) Inventors: Mary Jo Viederman, Washington, DC (US); Derrish Repchick, Putney, VT (US); Tchiki Davis, Berkeley, CA (US)

(21) Appl. No.: 15/956,328

(22) Filed: Apr. 18, 2018

Related U.S. Application Data
(60) Provisional application No. 62/486,649, filed on Apr. 18, 2017.

(51) Int. Cl. G06Q 30/06; G06K 9/62

(52) U.S. Cl. CPC G06Q 30/0631; G06K 9/623; G06K 9/6248

(57) ABSTRACT

Techniques are described for taking actions based on multidimensional profile matching. A system defines a multi-dimensional user space that describes users and a multi-dimensional product space that describes products. The system also generates, for a user, a user profile that represents a vector within the multi-dimensional user space and generates, for multiple products, product profiles that each represent a vector within the multi-dimensional product space. The system further maps the user profile to a recommendation vector within the multi-dimensional product space and compares the recommendation vector to vectors within the multi-dimensional product space represented by the product profiles. Based on the comparison, the system determines, from among the multiple products, a subset of the multiple products to recommend to the user and outputs an interface that includes a recommendation for the user.

### CROSS-REFERENCE TO RELATED APPLICATION

This application claims the benefit of U.S. Provisional Application No. 62/486,649, filed Apr. 18, 2017, and titled “Multidimensional Profile Matching,” which is incorporated by reference in its entirety.

### FIELD

The present application relates to taking actions based on multidimensional profile matching.

### BACKGROUND

A recommender system or a recommendation system is a subclass of information filtering system that seeks to predict the rating or preference a user would give to an item. Recommender systems typically produce a list of recommendations in one of two ways—through collaborative filtering or through content-based filtering (also known as the personality-based approach). Collaborative filtering approaches build a model from a user's past behavior as well as similar decisions made by other users. This model is then used to predict items (or ratings for items) that the user may have an interest in. Content-based filtering approaches use a series of discrete characteristics of an item in order to recommend additional items with similar properties. These approaches may be combined to produce Hybrid Recommender Systems.

### SUMMARY

Techniques are described for taking actions based on multidimensional profile matching. In one aspect, a computer-implemented method provides a recommendation based on multidimensional profile matching. The method includes defining a multi-dimensional user space that describes users of a recommendation system, each dimension of the multi-dimensional user space representing an independent characteristic of a user, and defining a multi-dimensional product space that describes products associated with the recommendation system, each dimension of the multi-dimensional product space representing an independent characteristic of a product. The method also includes generating, for a user of the recommendation system, a user profile that represents a vector within the multi-dimensional user space and generating, for multiple products associated with the recommendation system, product profiles that each represent a vector within the multi-dimensional product space. The method further includes mapping, by the recommendation system, the user profile for the user of the recommendation system to a recommendation vector within the multi-dimensional product space, the recommendation vector representing a location within the multi-dimensional product space corresponding to the vector within the multi-dimensional user space represented by the user profile for the user of the recommendation system.

In addition, the method includes comparing, by the recommendation system, the recommendation vector within the multi-dimensional product space to vectors within the multi-dimensional product space represented by the product profiles for the multiple products associated with the recommendation system and, based on the comparison of the recommendation vector within the multi-dimensional product space to vectors within the multi-dimensional product space represented by the product profiles, determining, by the recommendation system and from among the multiple products associated with the recommendation system, a subset of the multiple products to recommend to the user. The method also includes outputting, by the recommendation system, an interface that includes a recommendation for the user based on the subset of the multiple products.

Implementations may include one or more of the following features. For example, the method may include calculating ranks for each product recommendation for the subset of the multiple products to indicate a quality of the match for the user, and outputting the interface that includes the recommendation for the user based on the calculated ranks for each product recommendation for the subset of the multiple products.

In some implementations, the method may include recording, by the recommendation system, historical records of successful matches between products and users based on feedback gathered by the recommendation system as to level of satisfaction, joining, by the recommendation system, user and product profile vectors for each successful match recorded in the historical records, and using, by the recommendation system, the joined user and product profile vectors as training data to build a set of predictive models. In these implementations, the method may include mapping the user profile for the user of the recommendation system to the recommendation vector within the multi-dimensional product space based on the set of predictive models and providing values for dimensions in the user profile as input to the set of predictive models and outputting, from each predictive model, a value of a single product dimension.

In some examples, the method may include using a supervised learning process for predicting a continuous variable. In these examples, using the supervised learning process for predicting the continuous variable may include using linear regression, random forest, or neural network processing.

In some implementations, the method may include building a training data set for each product dimension by joining values for a single product dimension from the joined product profile vectors with user dimension values in the joined user profile vectors and using each training data set to create a predictive model in the recommendation system for an associated product dimension. In these implementations, the method may include using the set of predictive models to create a profile vector for the user in the product space, comparing the created profile vector for the user in the product space to product profile vectors of the product profiles for the multiple products associated with the recommendation system, and generating a subset of recommended products for the user by finding the product profile vectors that are closest in distance to the created profile vector for the user in the product space.

In addition, the method may include creating a profile vector for the user in the product space that provides a quantitative description of the user in the product space. The method also may include calculating a distance value between each product profile vector and the created profile vector for the user in the product space, the distance value comprising a Euclidean Distance, a Manhattan Distance, or a Cosine Distance.

Further, the method may include defining the multi-dimensional user space to include at least one dimension representing an independent physical characteristic and at least one dimension representing an independent emotional characteristic. The method also may include defining the multi-dimensional product space to include at least one dimension representing an independent physical characteristic and at least one dimension representing an independent experience characteristic.

In some examples, the method may include receiving, from one or more users, responses to a set of questions about the user and generating the vector within the multi-dimensional user space based on the responses to the set of questions about the user. In these examples, the method may include receiving, from multiple users, responses to the set of questions about the user and combining question responses from the multiple users to create a more accurate profile. In addition, the method may include mapping the responses to the set of questions about the user to dimensions in the multi-dimensional user space. And, for each question, the method may include using weight values to map a question response to the dimensions in the multi-dimensional user space using different weights, each weight value indicating a strength of correlation between the question and one of the dimensions in the multi-dimensional user space.

In some implementations, the method may include receiving, from one or more users, responses to a set of questions about the products and generating vectors within the multi-dimensional user space for the product profiles based on the responses to the set of questions about the products. In these implementations, the method may include mapping the responses to the set of questions about the products to dimensions in the multi-dimensional product space. Also, for each question, the method may include using weight values to map a question response to the dimensions in the multi-dimensional product space using different weights, each weight value indicating a strength of correlation between the question and one of the dimensions in the multi-dimensional product space.

Additional aspects of the disclosure include a system with a processor and a tangible, non-transitory computer readable medium that are configured to implement the method described above. Also, the method described above may be implemented using a client/server architecture where a server interacts with multiple clients, which include any type of computer or mobile device, such as a cellular phone that interacts with the server using a mobile application.

### BRIEF DESCRIPTION OF DRAWINGS

FIG. 1 illustrates an example of Identifying The Profile Dimensions For Each Profile Space

FIG. 2 illustrates an example of Generating The Profile Questions

FIG. 3 illustrates an example of Assigning Response Weights To Questions

FIG. 4 illustrates an example of Responses To Profile Questions

FIG. 5 illustrates an example of Calculating The Person Profile Vector

FIG. 6 illustrates an example of Calculating The Gift Profile Vector

FIG. 7 illustrates an example of Building The Predictive Models

FIG. 8 illustrates an example Mapping Between the Profile Spaces

FIG. 9 illustrates an example of Finding Nearest Gifts

FIG. 10 illustrates an example System Overview

### DETAILED DESCRIPTION

A system is described for recommending gifts for a person that correlate to a high level of satisfaction with the gift. The technique is based on finding the closest match between a profile that is created for the gift and the person. The closer the profiles match the more likely the person will be satisfied with the gift. The profiles provide a quantitative description of the person and the gift using multiple dimensions that represent a combination of known aspects of an individual's personality (i.e., Big 5 Personality traits) and plausible aspects that likely contribute to gift preference (e.g., their passions and their purpose). The system creates these profiles by recording the responses to a set of carefully designed questions. The system uses a set of questions that are created based on input from experts in the psychology of gift giving using survey-design best practices (e.g., regarding question construction and comparisons to criterion measures) and are closely correlated to the dimensions of the profiles. This allows the system to map the question responses to the dimensions of the profile. The system combines question responses from multiple respondents to create a more accurate profile (i.e. “The Wisdom of Crowds”).

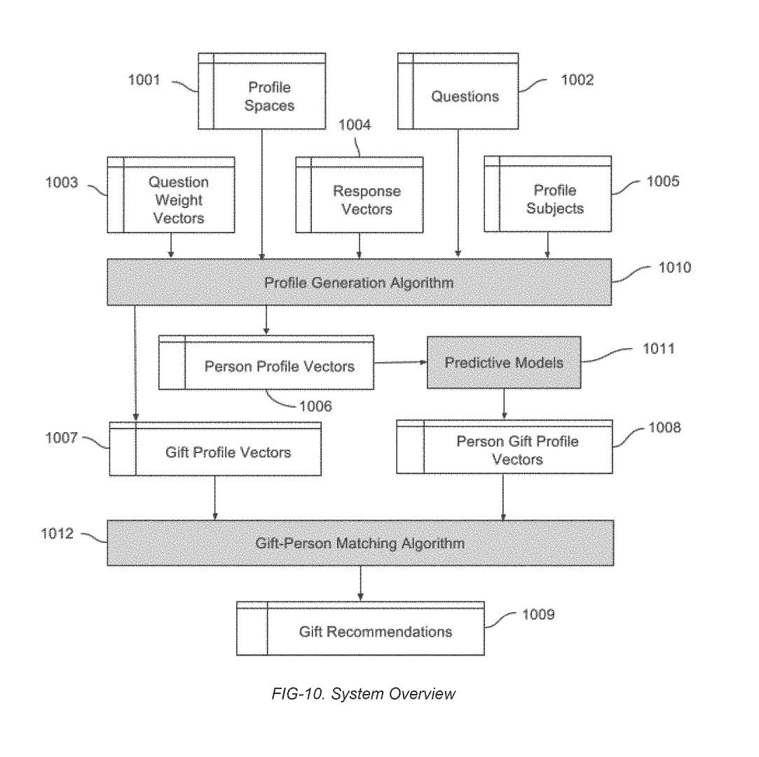

The system shown in FIG. 10 maintains a set of data tables based on data that is captured from human “users” and “experts” (1001, 1002, 1003, 1004, 1005). Experts are a subclass of users that are skilled in the psychology of gift giving enabling the system to gather higher quality data for use in the processes. These data tables identify entities such as gifts and persons (1005), attributes of the gifts and persons that are relevant to gift giving (1001), questions for quantifying those attributes for gifts and persons (1002), responses to the questions (1004) recorded from users and the strength of the correlation between the responses to questions and the attributes of the gifts and persons (1003).

The data the system collects from the users (1001, 1002, 1003, 1004, 1005) is used to generate additional data tables that provide a quantitative description of the gifts and persons (1006, 1007, 1008) via a profile generation algorithm (1010) and a set of predictive models (1011). The system uses the quantitative descriptions (1007, 1008) to generate a table of recommended gifts (1009) for each person via the gift-person matching algorithm (1012). The system calculates a rank for each gift recommendation to indicate the quality of the match for the person.

The system uses “profile dimensions” as the basis for describing a profile of a person or a gift. The profile dimensions represent a set of independent variables that are used to describe both the person and the gift. The profile dimensions are selected by identifying the aspects of the person and the gift (“profile subjects”) that provide strong correlation to satisfaction with the gift. The system allows experts to identify a set of profile dimensions for people (“person dimensions”) and another set for gifts (“gift dimensions”). The person dimensions and the gift dimensions define the “person space” and the “gift space”, respectively. In general, the person space and the gift space are referred to as “profile spaces”. The system manages the profile dimensions in data tables and uses them in several algorithms.

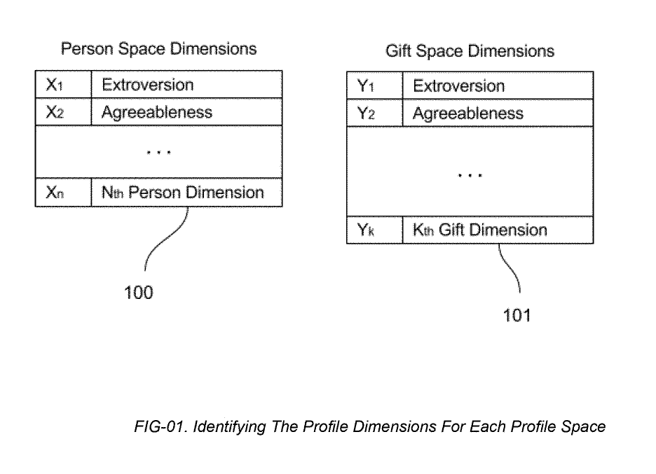

FIG. 1 shows an example of the profile dimensions created in the system for the person space (100) and the gift space (101).

The system manages a set of questions for people (“person questions”) and another set of questions for gifts (“gift questions”) in data tables. The person questions and gift questions are more generally referred to as “questions”. The system assists the experts in designing the questions so they are strongly correlated with one or more of the profile dimensions in their associated profile space. The person questions have a strong correlation to the person dimensions and the gift questions have a strong correlation to the gift dimensions. The system assists the experts in testing these questions to confirm that a strong correlation with the profile dimensions exists. This testing will also provide a measure of the strength of the correlation that will be used to weight the questions relative to the profile dimensions. The questions are used by the system in the profile generation algorithm.

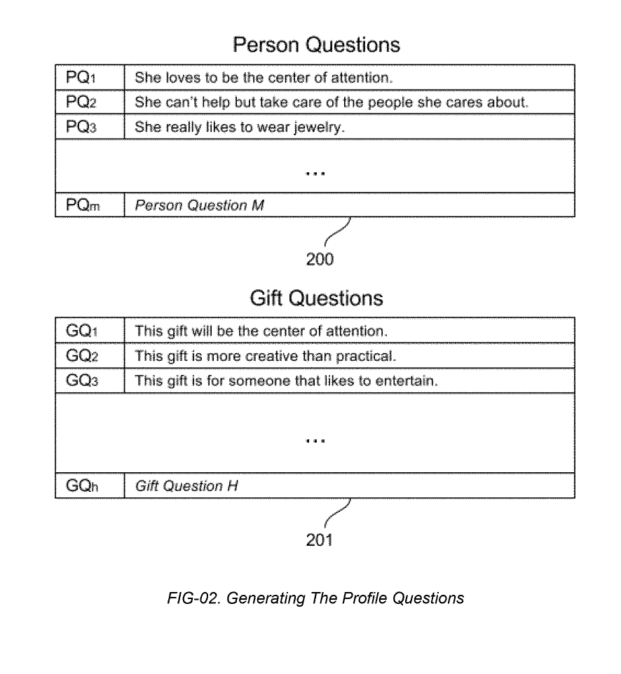

FIG. 2 provides an example of a set of person questions 200 and gift questions 201 that were created in the system.

The system indicates the strength of the correlation between questions and the profile dimensions via a weight value. Each question has a weight value for each profile dimension in the associated profile space. The set of weights for a single question is referred to as a “question weight vector”. The question weight vectors are maintained by the system in a data table. A person question will have question weight vector (“person question weight vector”) with a length equal to the number of profile dimensions in the person space. A gift question will have question weight vector (“gift question weight vector”) with a length equal to the number of profile dimensions in the gift space. Both the person question weight vector and the gift weight vector are more generally referred to as question weight vectors. The question weight vector contains a set of numerical values that indicate the strength of the correlation between the question and the profile dimensions in the profile space. A larger absolute value indicates a stronger correlation to a profile dimension. A negative value indicates an inverse relationship between the question and the profile dimension.

The system can gather multiple question weight vectors for a single question from multiple experts to increase the accuracy. A single question has one question weight vector for each expert (“expert question weight vector”). The system will aggregate the expert question weight vectors into a single question weight vector by averaging the values for each dimension.

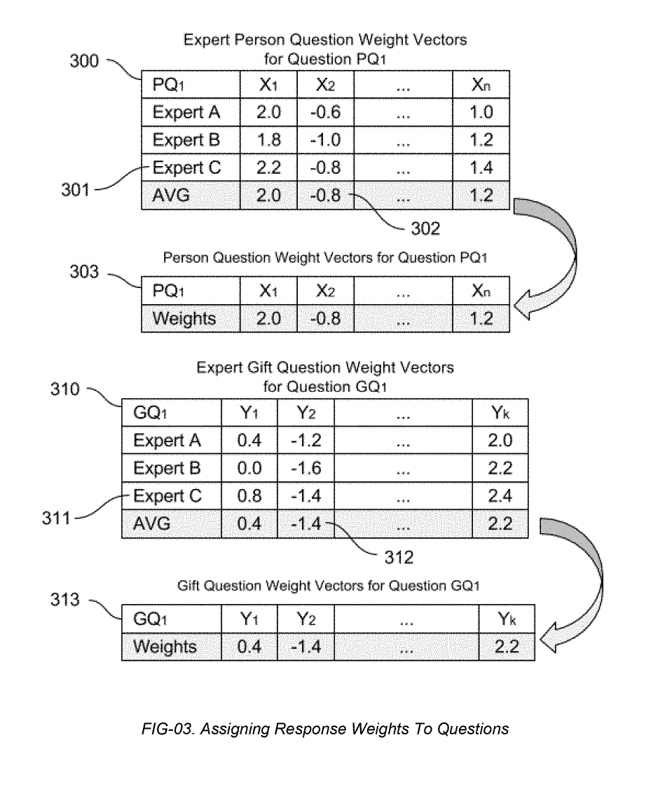

FIG. 3 provides an example of the approach for generating a single question weight vector within the system. The system gathers multiple expert question weight vectors for a person question (300). The system averages the weight values for each dimension in the expert question weight vectors (302) to create a single person question weight vector (303). The system uses this same approach for a gift question. The system gathers multiple expert question weight vectors for a gift question (310). The system averages the profile dimensions (312) of the expert question weight vectors (311) to create a single gift question weight vector (313).

The system collects and stores responses to questions from users in a data table. A response to a question is stored as a numeric value from −1.0 to 1.0. This value corresponds to how strongly the user agrees with the assertion stated in the question. A value of 1.0 indicates they strongly agree and a value of −1.0 indicates they strongly disagree. A set of responses about a specific profile subject is defined as a “response vector”. The length of the response vector is equal to the number questions in the associated profile space.

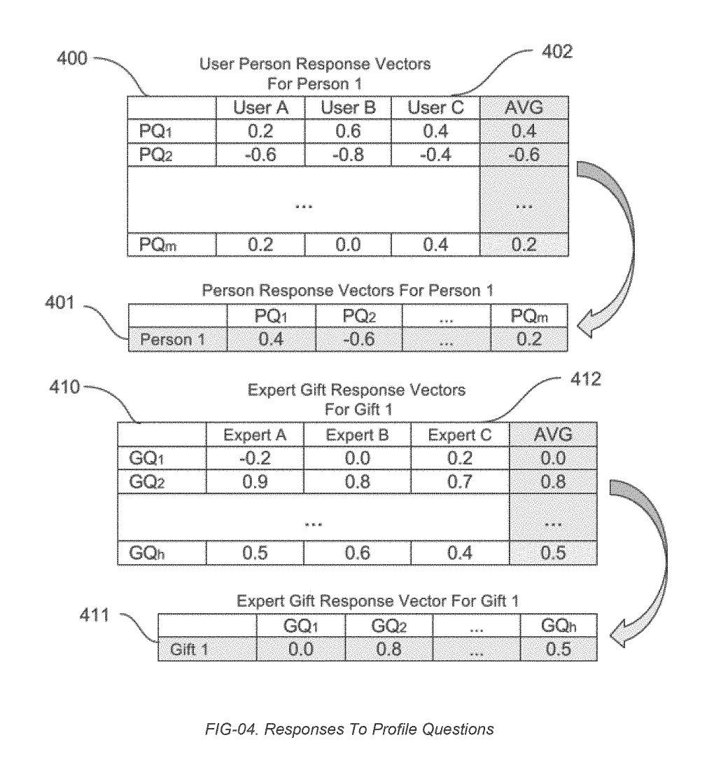

FIG. 4 shows an example of the response values collected by the system for a single person (400) by multiple users. Each column (402) is a response vector for a single user for a person (“user person response vector”). The system combines the set of user person response vectors by averaging the response values for each question to create the “person response vector” (401). The figure shows an example of the response values collected by the system for a single gift (410) by multiple experts. Each column (412) is a response vector for a single expert for a gift (“expert gift response vector”). The system combines the set of expert gift response vectors by averaging the response values for each question to create the “gift response vector” (411).

The system combines the response vector and question weight vectors to produce a “profile vector.” A profile vector has a numerical value for each profile dimension for a single profile subject. The system calculates the values for each dimension of the profile vector using a weighted average of the response values for each question for a single profile subject. The system uses the weight values from the question weight vectors. The system has two types of profile vectors, “person profile vectors” and “gift profile vectors”, one for each profile subject. A person profile vector has a length equal to the number of person dimensions and a gift profile vector has a length equal to the number of gift dimensions. The system manages person profile vectors and gift profile vectors in data tables. These tables are populated by the system via the profile generation algorithm.

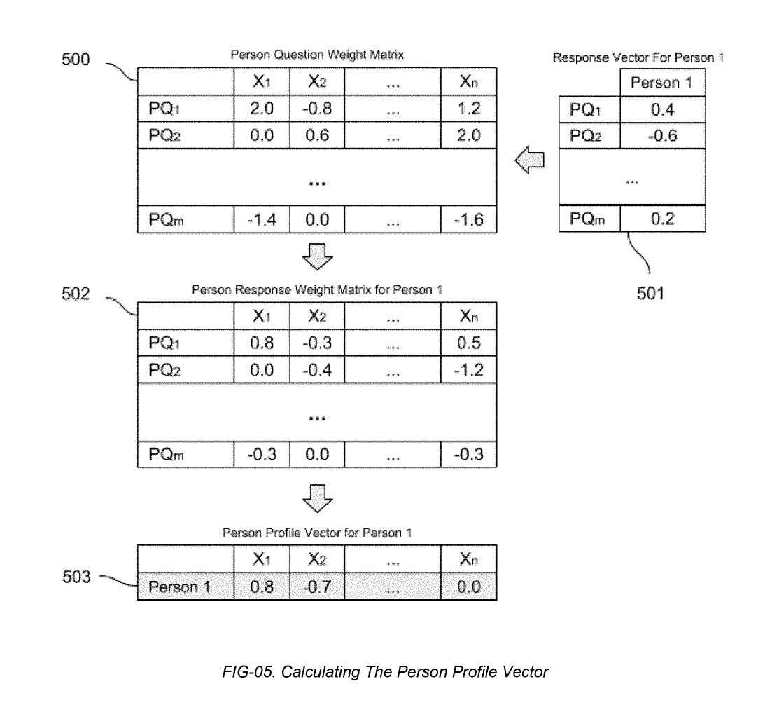

FIG. 5 shows an example of the profile generation algorithm used by the system for calculating the person profile vector for a single person (503). The system uses the set of person question weight vectors to create a two dimensional “person question weight matrix” (500). The person question weight matrix has a row for each person question and a column for each person dimension. The system multiplies the weight values for each question in the person question weight matrix by the response value for the corresponding question in the person response vector for that person (501) to create the “person response weight matrix” (502). The system averages the values for each person dimension in the person response weight matrix to create the person profile vector for that person.

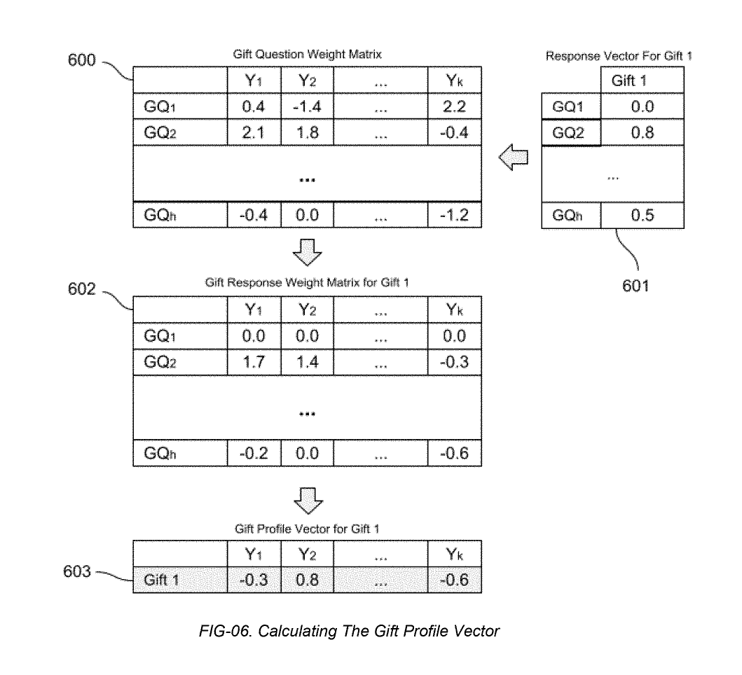

FIG. 6 shows an example of the profile generation algorithm used by the system for calculating the gift profile vector for a single gift (603). The system uses a set of gift question weight vectors to create a two dimensional “gift question weight matrix” (600). The gift question weight matrix has a row for each gift question and a column for each gift dimension. The system multiplies the weight values for each question in the gift question weight matrix by the response value for the corresponding question in the gift response vector for that gift (601) to create the “gift response weight matrix” (602). The system averages the values for each gift dimension in the gift response weight matrix to create the gift profile vector for that gift.

The system records a historical record of successful matches between gifts and people. A successful match is identified based on feedback gathered by the system from the person receiving the gift about their level of satisfaction. The system joins the person and gift profile vectors for each successful match. This provides the system with training data to build a set of “predictive models”. Each predictive model outputs the value of a single gift dimension by using the values for the person dimensions in a person profile vector as inputs. The predictive models are built in the system using a supervised learning algorithm for predicting a continuous variable such as linear regression, random forest, neural network, etc.

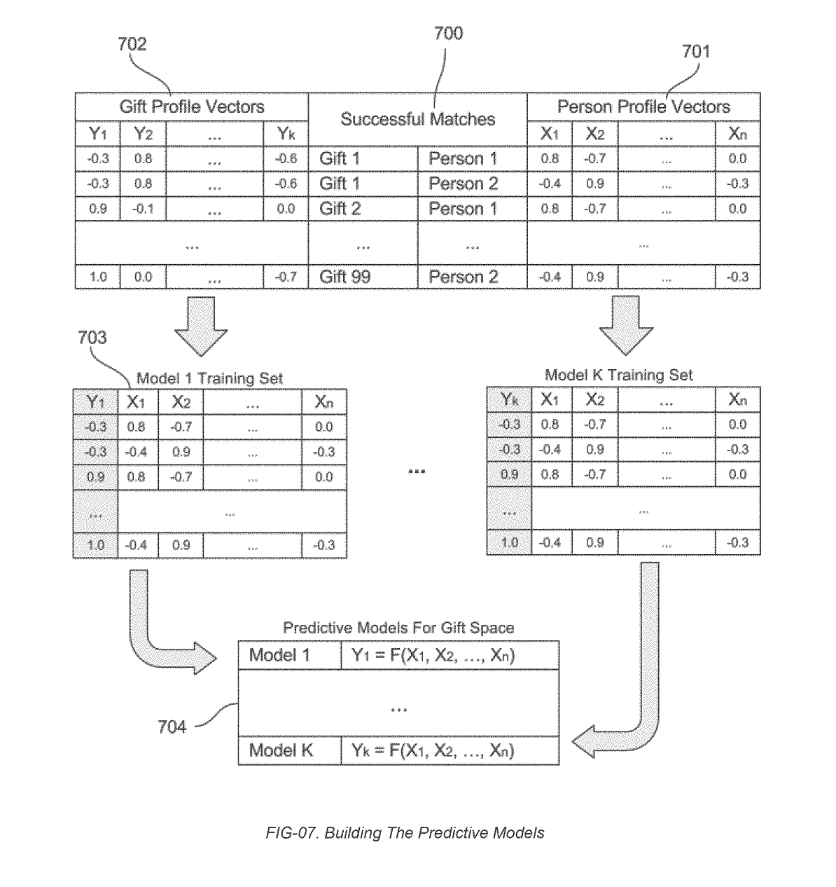

FIG. 7 shows an example of the system building the predictive models for the gift dimensions. The system joins the person profile vectors (701) and gift profile vectors (702) based on a successful match record (700). A training data set is built for each gift dimension (“gift dimension training set”) (703) by joining the values for a single gift dimension from the gift profile vectors with the person dimension values in the joined person profile vectors. Each gift dimension training set is used to create a predictive model in the system for the associated gift dimension (704).

The system uses the predictive models to create a profile vector for the person in the gift space. This allows the system to compare a person profile to gift profiles as part of the gift-person matching algorithm.

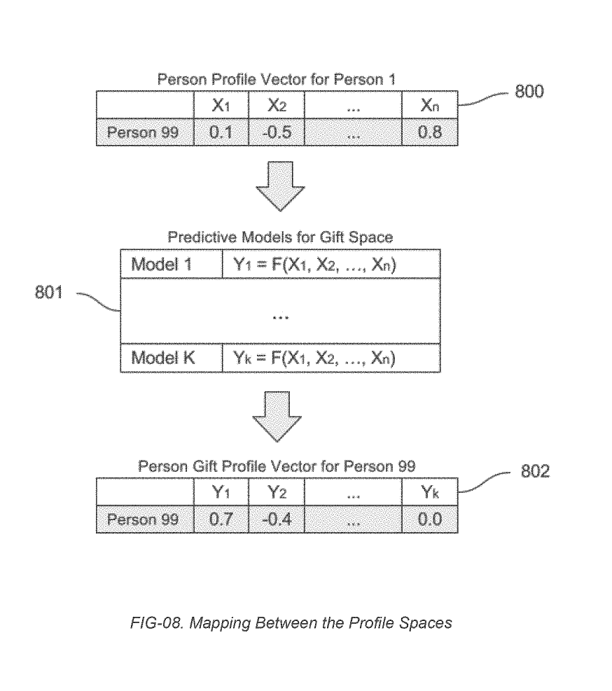

FIG. 8 shows an example of how the system maps the person profile vector for a person (800) into a profile vector in the gift space (“person gift profile vector”) (802) using the predictive models (801). Each predictive model in the system uses the person dimension values from a person profile vector as input and outputs a single gift dimension value in the person gift profile vector. The person gift profile vector provides a quantitative description of the person in the gift space.

The system generates a set of recommended gifts for a specific person by finding the gift profile vectors that are closest in distance to the person gift profile vector for the person.

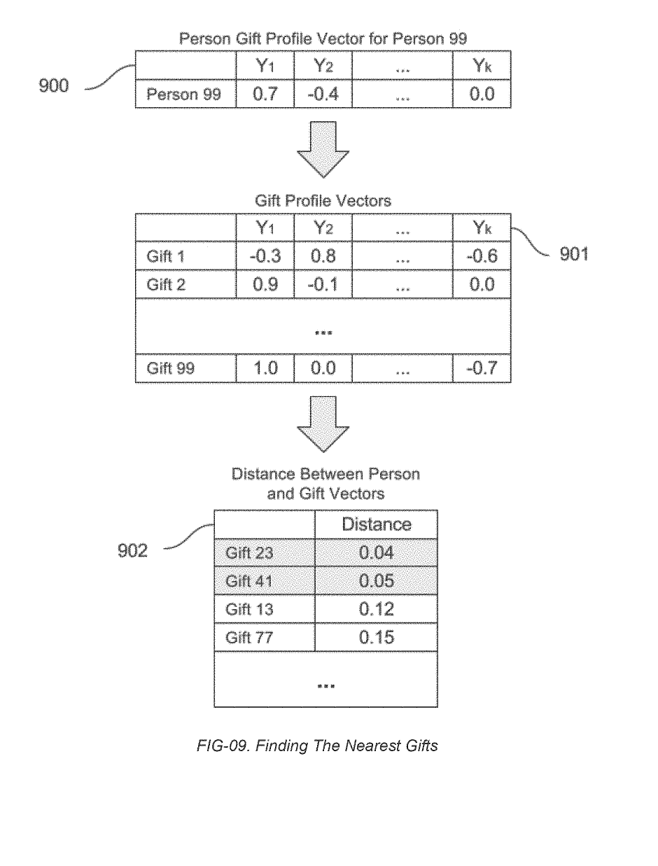

FIG. 9 shows how the system calculates a distance value (903) between each gift profile vector (902) and the person gift profile vector for a person (900). The distance value may be a Euclidean Distance, a Manhattan Distance, a Cosine Distance, or another suitable distance value. The system orders the gifts in ascending order based on the distance value. The distance value is the basis for ranking the matching gifts. The system selects a subset of the gifts with the lowest rank value as the recommended gifts for the person.

Other useful implementations could be achieved if steps of the disclosed techniques were performed in a different order and/or if components in the disclosed systems were combined in a different manner and/or replaced or supplemented by other components. Accordingly, other implementations are within the scope of the disclosure.

What is claimed is:

1. A computer-implemented method for providing a recommendation based on multidimensional profile matching, the method comprising:
defining a multi-dimensional user space that describes users of a recommendation system, each dimension of the multi-dimensional user space representing an independent characteristic of a user;
defining a multi-dimensional product space that describes products associated with the recommendation system, each dimension of the multi-dimensional product space representing an independent characteristic of a product;
generating, for a user of the recommendation system, a user profile that represents a vector within the multi-dimensional user space;
generating, for multiple products associated with the recommendation system, product profiles that each represent a vector within the multi-dimensional product space;
mapping, by the recommendation system, the user profile for the user of the recommendation system to a recommendation vector within the multi-dimensional product space, the recommendation vector representing a location within the multi-dimensional product space corresponding to the vector within the multi-dimensional user space represented by the user profile for the user of the recommendation system;
comparing, by the recommendation system, the recommendation vector within the multi-dimensional product space to vectors within the multi-dimensional product space represented by the product profiles for the multiple products associated with the recommendation system;
based on the comparison of the recommendation vector within the multi-dimensional product space to vectors within the multi-dimensional product space represented by the product profiles, determining, by the recommendation system and from among the multiple products associated with the recommendation system, a subset of the multiple products to recommend to the user; and
outputting, by the recommendation system, an interface that includes a recommendation for the user based on the subset of the multiple products.

2. The method of claim 1, further comprising calculating ranks for each product recommendation for the subset of the multiple products to indicate a quality of the match for the user,
wherein outputting the interface that includes the recommendation for the user based on the subset of the multiple products comprises outputting the interface that includes the recommendation for the user based on the calculated ranks for each product recommendation for the subset of the multiple products.

3. The method of claim 1, further comprising:
recording, by the recommendation system, historical records of successful matches between products and users based on feedback gathered by the recommendation system as to level of satisfaction;
joining, by the recommendation system, user and product profile vectors for each successful match recorded in the historical records; and
using, by the recommendation system, the joined user and product profile vectors as training data to build a set of predictive models,
wherein mapping the user profile for the user of the recommendation system to the recommendation vector within the multi-dimensional product space comprises mapping the user profile for the user of the recommendation system to the recommendation vector within the multi-dimensional product space based on the set of predictive models.

4. The method of claim 3, wherein mapping the user profile for the user of the recommendation system to the recommendation vector within the multi-dimensional product space based on the set of predictive models comprises providing values for dimensions in the user profile as input to the set of predictive models and outputting, from each predictive model, a value of a single product dimension.

5. The method of claim 3, wherein using the joined user and product profile vectors as training data to build the set of predictive models comprises using a supervised learning process for predicting a continuous variable.

6. The method of claim 5, wherein using the supervised learning process for predicting the continuous variable comprises using linear regression, random forest, or neural network processing.

7. The method of claim 3, wherein using the joined user and product profile vectors as training data to build the set of predictive models comprises:
building a training data set for each product dimension by joining values for a single product dimension from the joined product profile vectors with user dimension values in the joined user profile vectors; and
using each training data set to create a predictive model in the recommendation system for an associated product dimension.

8. The method of claim 7:
wherein mapping the user profile for the user of the recommendation system to the recommendation vector within the multi-dimensional product space based on the set of predictive models comprises using the set of predictive models to create a profile vector for the user in the product space; and
wherein comparing the recommendation vector within the multi-dimensional product space to vectors within the multi-dimensional product space represented by the product profiles for the multiple products associated with the recommendation system comprises comparing the created profile vector for the user in the product space to product profile vectors of the product profiles for the multiple products associated with the recommendation system; and
wherein determining the subset of the multiple products to recommend to the user comprises generating a subset of recommended products for the user by finding the product profile vectors that are closest in distance to the created profile vector for the user in the product space.

9. The method of claim 8, wherein using the set of predictive models to create the profile vector for the user in the product space comprises creating a profile vector for the user in the product space that provides a quantitative description of the user in the product space.

10. The method of claim 8, wherein generating the subset of recommended products for the user by finding the product profile vectors that are closest in distance to the created profile vector for the user in the product space comprises calculating a distance value between each product profile vector and the created profile vector for the user in the product space, the distance value comprising a Euclidean Distance, a Manhattan Distance, or a Cosine Distance.

11. The method of claim 1, wherein defining the multi-dimensional user space that describes users of the recommendation system comprises defining the multi-dimensional user space to include at least one dimension representing an independent physical characteristic and at least one dimension representing an independent emotional characteristic.

12. The method of claim 1, wherein defining the multi-dimensional product space that describes products associated with the recommendation system comprises defining the multi-dimensional product space to include at least one dimension representing an independent physical characteristic and at least one dimension representing an independent experience characteristic.

13. The method of claim 1, wherein generating the user profile that represents the vector within the multi-dimensional user space comprises:
receiving, from one or more users, responses to a set of questions about the user, and
generating the vector within the multi-dimensional user space based on the responses to the set of questions about the user.

14. The method of claim 13:
wherein receiving responses to the set of questions about the user comprises receiving, from multiple users, responses to the set of questions about the user; and
wherein generating the vector within the multi-dimensional user space based on the responses to the set of questions about the user comprises combining question responses from the multiple users to create a more accurate profile.

15. The method of claim 13, wherein generating the vector within the multi-dimensional user space based on the responses to the set of questions about the user comprises mapping the responses to the set of questions about the user to dimensions in the multi-dimensional user space.

16. The method of claim 15, wherein mapping the responses to the set of questions about the user to dimensions in the multi-dimensional user space comprises, for each question, using weight values to map a question response to the dimensions in the multi-dimensional user space using different weights, each weight value indicating a strength of correlation between the question and one of the dimensions in the multi-dimensional user space.

17. The method of claim 1, wherein generating the product profiles that each represent a vector within the multi-dimensional product space comprises:
receiving, from one or more users, responses to a set of questions about the products, and
generating vectors within the multi-dimensional user space for the product profiles based on the responses to the set of questions about the products.

18. The method of claim 17, wherein generating vectors within the multi-dimensional user space for the product profiles based on the responses to the set of questions about the products comprises mapping the responses to the set of questions about the products to dimensions in the multi-dimensional product space.

19. The method of claim 18, wherein mapping the responses to the set of questions about the products to dimensions in the multi-dimensional product space comprises, for each question, using weight values to map a question response to the dimensions in the multi-dimensional product space using different weights, each weight value indicating a strength of correlation between the question and one of the dimensions in the multi-dimensional product space.

20. A recommendation system comprising:
at least one processor; and
at least one tangible, non-transitory computer-readable storage medium comprising instructions that, when executed by the at least one processor, cause the at least one processor to perform operations comprising:
defining a multi-dimensional user space that describes users of the recommendation system, each dimension of the multi-dimensional user space representing an independent characteristic of a user;
defining a multi-dimensional product space that describes products associated with the recommendation system, each dimension of the multi-dimensional product space representing an independent characteristic of a product;
generating, for a user of the recommendation system, a user profile that represents a vector within the multi-dimensional user space;
generating, for multiple products associated with the recommendation system, product profiles that each represent a vector within the multi-dimensional product space;
mapping the user profile for the user of the recommendation system to a recommendation vector within the multi-dimensional product space, the recommendation vector representing a location within the multi-dimensional product space corresponding to the vector within the multi-dimensional user space represented by the user profile for the user of the recommendation system;
comparing the recommendation vector within the multi-dimensional product space to vectors within the multi-dimensional product space represented by the product profiles for the multiple products associated with the recommendation system;
based on the comparison of the recommendation vector within the multi-dimensional product space to vectors within the multi-dimensional product space represented by the product profiles, determining, from among the multiple products associated with the recommendation system, a subset of the multiple products to recommend to the user; and
outputting an interface that includes a recommendation for the user based on the subset of the multiple products.
